(19) United States
(12) Patent Application Publication
(10) Pub. No.: US 2025/0030612 A1
(43) Pub. Date: Jan. 23, 2025

(54) METHODS, DEVICES, AND MEDIUM FOR COMMUNICATION

(71) Applicant: NEC CORPORATION, Tokyo (JP)

(72) Inventors: Peng GUAN, Beijing (CN); Gang WANG, Beijing (CN)

(73) Assignee: NEC CORPORATION, Tokyo (JP)

(21) Appl. No.: 18/713,049

(22) PCT Filed: Nov. 24, 2021
(86) PCT No.: PCT/CN2021/132889

§ 371 Date: May 23, 2024

(51) Int. Cl. H04L 41/16; H04W 24/02; H04W 76/28

(52) U.S. Cl. CPC H04L 41/16; H04W 24/02; H04W 76/28

(57) ABSTRACT

Example embodiments of the present disclosure relate to an effective mechanism for handing the scenario of discontinuous coverage. In this solution, the device in the network may obtain at least one configuration associated with a machine learning (ML) model. In particular, the at least one configuration indicates at least one first duration to obtain both an inference result generated by the ML model and a measurement result corresponding to the ML model. By applying the at least one configuration, the inference error may be detected and the incorrect inference may be well handled thereby.

### FIELD

Example embodiments of the present disclosure generally relate to the field of communication techniques and in particular, to methods, devices, and medium for detecting and handling an inference error of a machine learning (ML) model.

### BACKGROUND

As communication networks and services increase in size, complexity, and number of users, communications in the communication networks may become increasingly more complicated. In order to improve the communication performance, ML/artificial intelligence (AI) technology is proposed to be used in the wireless communication network. In particular, it is proposed that the ML/AI technology may be used for the air interface interactions (i.e., the interaction between a terminal device and a network device). In this event, it is expected that the ML/AI model may be efficiently distributed to the related network elements including the terminal device and the network device.

Further, the inference results generated by a ML/AI model are not always accurate. The inaccurate inference results would bring a plurality of negative impacts, such as, unsuccessful communication, waste of radio resource and so on. Therefore, it is desirable to propose a solution for detecting and handling the inference error of a ML model.

### SUMMARY

In general, example embodiments of the present disclosure provide a solution for detecting and handling an inference error of a ML model. Embodiments that do not fall under the scope of the claims, if any, are to be interpreted as examples useful for understanding various embodiments of the disclosure.

In a first aspect, there is provided a method of communication. The method comprises: receiving, at a first device and from a second device, at least one configuration associated with a ML model, the at least one configuration indicating at least one first duration to obtain both an inference result generated by the ML model and a measurement result corresponding to the ML model; and applying the at least one configuration.

In a second aspect, there is provided a method of communication. The method comprises: detecting, at a terminal device, a pre-defined event that indicates an inference error of a ML model, the pre-defined event being defined specifically to a particular functionality on an air interface; and transmitting, to a network device, a request for updating the ML model.

In a third aspect, there is provided a method of communication. The method comprises: receiving, at a first device and from a second device, one or more ML models, the one or more ML models being received via at least one of the following: a specific radio network temporary identity (RNTI), a specific control resource set (CORESET), a specific search space set, or one of group common transmission and broadcast.

In a fourth aspect, there is provided a method of communication. The method comprises: generating at a second device, at least one configuration associated with a ML model, the at least one configuration indicating at least one first duration to obtain both an inference result generated by the ML model and a measurement result corresponding to the ML model; and transmitting the at least one configuration.

In a fifth aspect, there is provided a method of communication. The method comprises: transmitting, at a second device and to a first device, one or more ML models, the one or more models being transmitted via at least one of the following: a specific RNTI, a specific CORESET, a specific search space set, or one of group common transmission and broadcast.

In a sixth aspect, there is provided a first device. The first device includes a processing unit; and a memory coupled to the processing unit and storing instructions thereon, the instructions, when executed by the processing unit, causing the device to perform the method according to the first aspect.

In a seventh aspect, there is provided a terminal device. The terminal device includes a processing unit; and a memory coupled to the processing unit and storing instructions thereon, the instructions, when executed by the processing unit, causing the device to perform the method according to the second aspect.

In an eighth aspect, there is provided a first device. The first device includes a processing unit; and a memory coupled to the processing unit and storing instructions thereon, the instructions, when executed by the processing unit, causing the device to perform the method according to the third aspect.

In a ninth aspect, there is provided a second device. The second device includes a processing unit; and a memory coupled to the processing unit and storing instructions thereon, the instructions, when executed by the processing unit, causing the device to perform the method according to the fourth aspect.

In a tenth aspect, there is provided a second device. The second device includes a processing unit; and a memory coupled to the processing unit and storing instructions thereon, the instructions, when executed by the processing unit, causing the device to perform the method according to the fifth aspect.

In a eleventh aspect, there is provided a computer readable medium having instructions stored thereon, the instructions, when executed on at least one processor, causing the at least one processor to carry out the method according to any of the above first to fifth aspects.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Through the more detailed description of some example embodiments of the present disclosure in the accompanying drawings, the above and other objects, features and advantages of the present disclosure will become more apparent, wherein:

FIG. 1 illustrates a proposed functional framework of a ML process.

FIG. 2 illustrates an example communication environment in which example embodiments of the present disclosure can be implemented;

FIGS. 3A to 3C illustrate types of AI/ML operation supported by the present disclosure;

FIG. 4 illustrates a signaling chart illustrating a process for communication according to some embodiments of the present disclosure;

FIGS. 5A and 5B illustrate example operating timings at the first/second device according to some embodiments of the present disclosure;

FIG. 6 illustrates another example operating timing at the first/second device according to some embodiments of the present disclosure;

FIG. 7 illustrates an example method performed by the first device according to some embodiments of the present disclosure;

FIG. 8 illustrates an example method performed by a terminal device according to some embodiments of the present disclosure;

FIG. 9 illustrates an example method performed by the first device according to some embodiments of the present disclosure;

FIG. 10 illustrates an example method performed by the second device according to some embodiments of the present disclosure;

FIG. 11 illustrates an example method performed by the second device according to some embodiments of the present disclosure; and

FIG. 12 illustrates a simplified block diagram of an apparatus that is suitable for implementing example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

In some examples, values, procedures, or apparatus are referred to as “best,” “lowest,” “highest,” “minimum,” “maximum,” or the like. It will be appreciated that such descriptions are intended to indicate that a selection among many used functional alternatives can be made, and such selections need not be better, smaller, higher, or otherwise preferable to other selections.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G), 5.5G, 5G-Advanced networks, or the sixth generation (6G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “terminal device” refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Ultra-reliable and Low Latency Communications (URLLC) devices, Internet of Everything (IoE) devices, machine type communication (MTC) devices, device on vehicle for V2X communication where X means pedestrian, vehicle, or infrastructure/network, devices for Integrated Access and Backhaul (IAB), Space borne vehicles or Air borne vehicles in Non-terrestrial networks (NTN) including Satellites and High Altitude Platforms (HAPs) encompassing Unmanned Aircraft Systems (UAS), extended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical, V2X applications, transparent IPv4/IPv6 multicast delivery, IPTV, smart TV, radio services, software delivery over wireless, group communications and IoT applications. It may also be incorporated one or multiple Subscriber Identity Module (SIM) as known as Multi-SIM. The term “terminal device” can be used interchangeably with a UE, a mobile station, a subscriber station, a mobile terminal, a user terminal or a wireless device.

As used herein, the term “network device” refers to a device which is capable of providing or hosting a cell or coverage where terminal devices can communicate. Examples of a network device include, but not limited to, a satellite, a unmanned aerial systems (UAS) platform, a Node B (NodeB or NB), an evolved NodeB (cNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), and the like.

The terminal device or the network device may have Artificial intelligence (AI) or Machine learning capability. It generally includes a model which has been trained from numerous collected data for a specific function, and can be used to predict some information.

The terminal or the network device may work on several frequency ranges, e.g. FR1 (410 MHZ-7125 MHZ), FR2 (24.25 GHz to 71 GHz), frequency band larger than 100 GHz as well as Tera Hertz (THz). It can further work on licensed/unlicensed/shared spectrum. The terminal device may have more than one connection with the network devices under Multi-Radio Dual Connectivity (MR-DC) application scenario. The terminal device or the network device can work on full duplex, flexible duplex and cross division duplex modes.

The embodiments of the present disclosure may be performed in test equipment, e.g. signal generator, signal analyzer, spectrum analyzer, network analyzer, test terminal device, test network device, channel emulator.

The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory(ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

As discussed above, it is expected that the ML/AI technology may be used for the air interface interaction. Specifically, a ML model (also referred to as AI model sometimes) may be applied at either or both of the terminal device and the network device. Generally speaking, a ML model refers to a data driven algorithm by applying ML techniques that generates a set of outputs consisting of predicted information based on a set of inputs. A ML model may be described and identified by different aspects, for example,
Characterize the defining stages of AI/ML related algorithms and associated complexity:
   Model generation, e.g., model training (including input/output, pre-/post-process, as applicable), model validation, model testing, as applicable.
   Inference operation, e.g., input/output, pre-/post-process, as applicable.
Identify various levels of collaboration between UE and gNB, e.g.,
   No collaboration: implementation-based only AI/ML algorithms without exchanging information for comparing.
   Various levels of UE/gNB collaboration targeting at separate or joint ML operation.
Identify lifecycle management of AI/ML model: e.g., model deployment (initiation/configuration), model monitoring, model updating, and model transfer.
Data set for training, inference, validation, and testing.
Identify common notation and terminology for AI/ML related functions, procedures and interfaces.

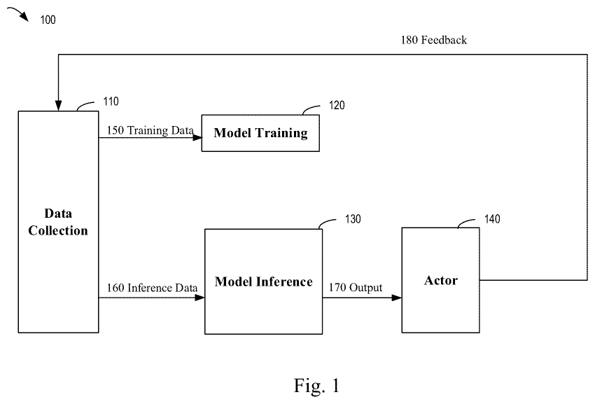

Further, a ML training is necessary for generating a ML model. As for the scenario of wireless communication, data to be used for ML training may be collected from the network nodes, management entities or UEs. Then, an online or offline process may be performed to train the ML model by learning features and patterns that best present data and get the trained ML model for inference. During the ML inference process, the trained ML model may be used to make a prediction or guide the decision based on collected data and ML model. Reference is now made to FIG. 1, which illustrates a proposed functional framework 100 of a ML process. As illustrated in FIG. 1, four key function blocks are involved in the proposed functional framework 100, i.e., Data Collection function 110, Model Training function 120, Model Inference function 130 and Actor function 140. Details about the above four key function blocks are discussed as below.
Data Collection function 110 is a function that provides input data to Model Training function 120 and Model Inference function 130. AI/ML algorithm specific data preparation (e.g., data pre-processing and cleaning, formatting, and transformation) is not carried out in the Data Collection function 110. Examples of input data may include measurements from UEs or different network entities, feedback from Actor, output from an AI/ML model.
   Training Data 150: data needed as input for the AI/ML Model Training function 120.
   Inference Data 160: data needed as input for the AI/ML Model Inference function 130.
Model Training function 120 is a function that performs the ML model training, validation, and testing. The Model Training function 120 is also responsible for data preparation (e.g. data pre-processing and cleaning, formatting, and transformation) based on Training Data 150 delivered by a Data Collection function 110, if required.
Model Inference function 130 is a function that provides AI/ML model inference output (i.e., Output 170, e.g. predictions or decisions). The Model Inference function 130 is also responsible for data preparation (e.g. data pre-processing and cleaning, formatting, and transformation) based on Inference Data delivered by a Data Collection function 110, if required.
   Output 170: the inference output of the AI/ML model produced by a Model Inference function 130.
Actor function 140 is a function that receives the output from the Model inference function 130 and triggers or performs corresponding actions. The Actor function 140 may trigger actions directed to other entities or to itself.
   Feedback 180: Information that may be needed to derive training Data 150 or Inference Data 160 or performance feedback.

It has been agreed that principles for applying ML/AI technology to wireless communication includes: detailed AI/ML algorithms and models are left for implementation, user data privacy needs to be preserved and support of AL/ML shall reuse the existing RAN architecture and new interfaces shall not be introduced.

In the following 3rd-generation partnership project (3GPP) release 18 (Rel-18), some study items and work items will focus on the works about AI/ML for air interface and AI/ML for Next Generation Radio Access Network (NG-RAN).

Recently, some discussions have been made about the AI/ML for air interface. For example, it is expected that the AI/ML may be applied to a plurality of uses cases. One example use case is channel state information (CSI) feedback, for example, overhead reduction, improved accuracy, prediction. Another example use case is beam management, for example, beam prediction in time, and/or spatial domain for overhead and latency reduction, beam selection accuracy improvement. A further example use case is positioning accuracy enhancements for different scenarios with heavy non-line of sight (NLOS) conditions. Other use cases including reference signal (RS) overhead reduction, radio resource management (RRM) mobility (for example, prediction in time or frequency for robustness, interruption and overhead reduction) and so on.

However, as discussed above, the inference results generated by a ML/AI model are not always accurate. The inaccurate inference results would bring a plurality of negative impacts/performance degradation. In the scenario of CSI feedback compression, if the recovered CSI is worse than the real channel, an unnecessary additional resource allocation may be resulted, while if recovered CSI is better than the real channel, an unsuccessful decoding may be resulted. Similarly, in another scenario of CSI prediction (i.e., low overhead CSI-RS), if predicted CSI is worse than the real channel, an unnecessary additional resource allocation may be resulted, while if predicted CSI is better than the real channel, an unsuccessful decoding may be resulted. In addition, indicating wrong beam in beam management may cause low signal-to-noise ratio (SNR) or even a beam failure, and the wrong time/frequency compensation in low overhead demodulation reference signal (DMRS) may cause an unsuccessful decoding.

Through the above discussions about the example scenarios, it can be clearly seen that it is desirable to propose a solution for detecting and handling an inference error of a ML model in the wireless communication network.

Further, there are usually more than one ML model needed to be distributed and a large number of users needed to be configured with the more than one ML model. Therefore, it is also expected that the ML/AI model may be efficiently distributed to the related network elements.

According to some example embodiments of the present disclosure, at least part of the above issues may be addressed, while it should be understood that the issues addressed by the present disclosure are not limited to the above illustrated issues.

Generally speaking, a cell may associate with a certain frequency resource, and further a certain frequency resource may be identified by a plurality of metrics, such as, band, band combination, frequency range, physical cell, bandwidth part (BWP), BWP group, carrier, component carrier (CC), carrier group, CC group and so on. In the following, some example embodiments are described with regard to “a cell”/“a cell group”. It is to be understood that such descriptions with regard to “a cell”/“a cell group” may be applied to band, band combination, frequency range, physical cell, BWP, BWP group, carrier, CC, carrier group, CC group and so on.

It is to be understood that the scenario where the ML model is used for the air interface would be especially benefit from the example embodiments of the present disclosure. However, it does not mean that the example embodiments of the present disclosure can be implemented only for this specific scenario. Actually, the example embodiments of the present disclosure may be implemented in any scenario. The present disclosure is not limited in this regard.

In the following text, merely for better understanding a terminal device and a network device would be used as examples of the first device and the second device, respectively. It should be understood that the embodiments described herein may be implemented among any suitable network elements unless there is a clear literal statement. Specifically, either of the first device and the second may be any of a terminal device, a network device, a core network device or other suitable network elements in the wireless communication.

In the following text, ML-based or ML-assisted, ML-based or ML-assisted beam management, and ML-based or ML-assisted low overhead RS will be discussed as example use cases merely for better understanding. It is to be understood that the embodiments described herein may be applied to any suitable use cases. Specifically,
The ML-based or ML-assisted CSI feedback may include: CSI feedback compression and recovery, joint CSI predication at network (NW) and UE based on limited CSI-RS transmission, sounding reference signal (SRS) transmission or CSI feedback (in time-domain, frequency-domain, spatial-domain, antenna-port-domain and so on), CSI predication at NW based on limited CSI feedback (in time-domain, frequency-domain, spatial-domain, antenna-port-domain and so on), CSI predication at NW based on limited SRS transmission (in time-domain, frequency-domain, spatial-domain, antenna-port-domain and so on), CSI predication at UE based on limited CSI-RS transmission (in time-domain, frequency-domain, spatial-domain, antenna-port-domain and so on), and the others.
The ML-based or ML-assisted beam management may include: joint beam selection or predication at NW and UE based on limited CSI-RS transmission, SRS transmission or beam report (in time-domain, frequency-domain, spatial-domain, antenna-port-domain and so on); beam selection at NW to infer the best beam based on subset of resources for measurement and report; beam selection at UE to infer the best beam based on limited CSI-RS transmission; beam prediction at NW based on limited beam report (in time-domain, frequency-domain, spatial-domain, antenna-port-domain and so on); beam predication at NW based on limited SRS transmission in time-domain, frequency-domain, spatial-domain, antenna-port-domain and so on; beam predication at UE based on limited CSI-RS transmission (in time-domain, frequency-domain, spatial-domain, antenna-port-domain and so on), and the others.
The ML-based or ML-assisted low overhead RS may include: low overhead SSB/CSI-RS/SRS/PTRS/UL DMRS/DL DMRS (in time-domain, frequency-domain, spatial-domain, antenna-port-domain and so on), and the others.

In addition, other use cases including such as positioning accuracy, RRM should also be supported.

For ease of discussion, some terms and expressions used in the following description are listed as below:
The term “first duration”: refers to a duration to obtain both an inference result generated by a ML model and a measurement result corresponding to the ML model; also referred to as “validation time duration” sometimes.
The term “second duration”: refers to a duration to obtain an inference result generated by a ML model; also referred to as “inference only time duration” sometimes.
The term “inference cycle”: refers to a duration, which comprises a first duration, a second duration, at least one optional other duration and at least one optional gap in time domain; also referred to as “validation cycle” sometimes.
The term “time unit”: refers to a unit when describing a time length; further, a time unit may be any of a symbol, a slot, a subframe, a frame, a SFN, a millisecond and the likes.

In this present disclosure, some terms may refer to same or similar physical meaning and may be used interchangeably. Some exemplary examples are listed as below.
Terms “ML model”, “AI model”, and “algorithm” may be used interchangeably.
The terms “duration”, “window”, “period”, “timer” and “interval” may be used interchangeably.
The terms “functionality” and “use case” may be used interchangeably.
The terms “beam selection”, “beam measurement” and “beam report” may be used interchangeably; further, these terms may refer to “layer 1 reference signal received power (L1-RSRP) measurement and/or report”, or “layer 1 signal-to-interference-plus-noise-ratio (L1-SINR) measurement and/or report” sometimes.

### Example Environment

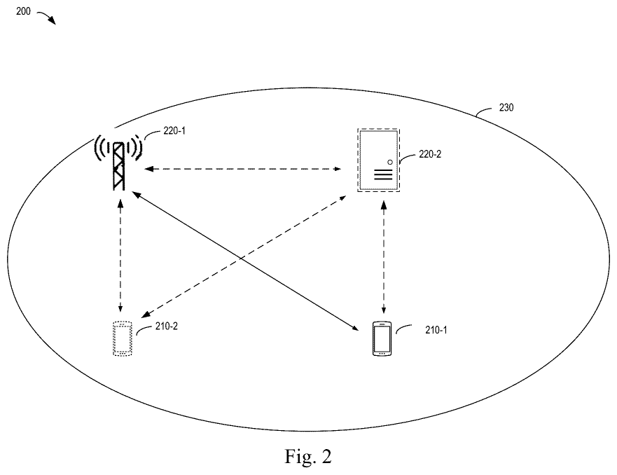

FIG. 2 shows an example communication environment 200 in which example embodiments of the present disclosure can be implemented.

In the communication environment 100, first device 210-1 and 210-2 (collectively or individually referred to as first devices 210) and second device 220-1 and 220-2 (collectively or individually referred to as second devices 220) are illustrated. The first devices 210 and the second devices 220 may communicate with each other via physical communication channels or links and some example connections are illustrated in FIG. 2. It is to be understood that the connections among the first devices 210 and the second devices 220 may be adjusted according to actual network deployment.

In the specific example of FIG. 2, the first devices 210-1 and 210-2 are illustrated as terminal devices. The second device 220-1 is illustrated as a network device serving the first devices 210-1 and 210-2. The serving area provided by the second device 220 is called as cell 230. Further, the second device 220-2 is illustrated as a ML function controller (also referred to as ML server sometimes).

It is to be understood that the number of devices and their connections shown in FIG. 2 are only for the purpose of illustration without suggesting any limitation. The environment 200 may include any suitable number of devices adapted for implementing embodiments of the present disclosure. Further, although not shown, it is to be understood that the communication environment 200 may comprise other network elements, such as, other core network device, other application servers and so on.

It would also be appreciated that in some examples, only the homogeneous network deployment or only the heterogeneous network deployment may be included in the communication environment 200.

The communications in the communication environment 200 may conform to any suitable standards including, but not limited to, Long Term Evolution (LTE), LTE-Evolution, LTE-Advanced (LTE-A), Wideband Code Division Multiple Access (WCDMA), Code Division Multiple Access (CDMA) and Global System for Mobile Communications (GSM) and the like. Furthermore, the communications may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G), 5.5G, 5G-Advanced networks, or the sixth generation (6G) communication protocols.

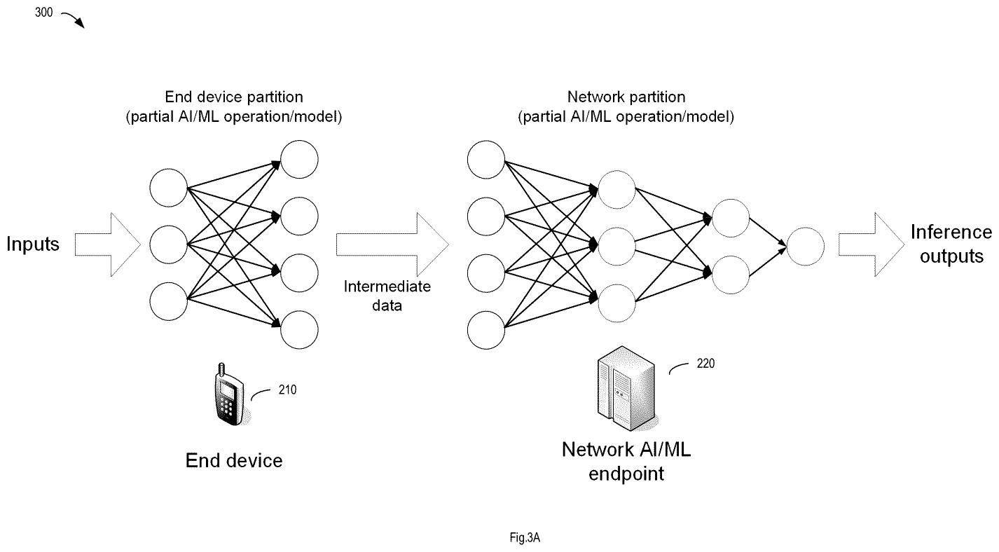

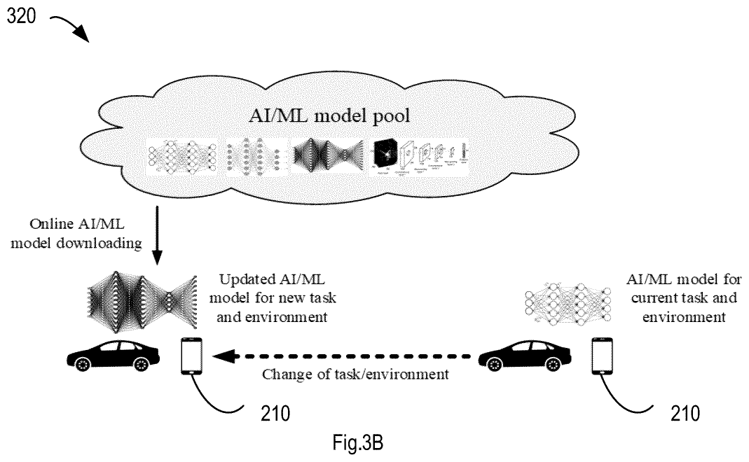

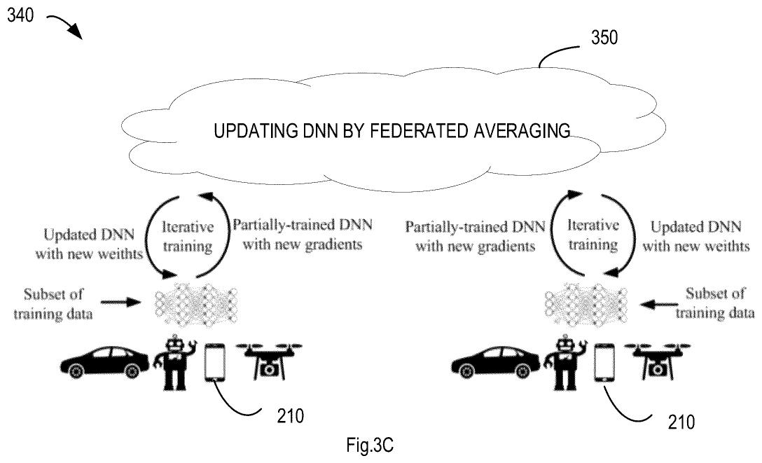

In addition, ML technology may be applied in the communication environment 200. Further, different types of AI/ML operation may be supported in the communication environment 200. Reference is now made to FIGS. 3A to 3C, which illustrated three example types of AI/ML operation 300, 320 and 340 supported by the present discourse. In the specific example of FIG. 3A, AI/ML operation is split between different AI/ML endpoints (i.e., end device, such as the first device 210 as shown in FIG. 2, network AI/ML endpoint, such as the second device 220 as shown in FIG. 2). Specifically, the AI/ML operation/model is split into multiple parts according to the current task and environment. The intention is to offload the computation-intensive, energy-intensive parts to network endpoints, whereas leave the privacy-sensitive and delay-sensitive parts at the end device. The device executes the operation/model up to a specific part/layer and then sends the intermediate data to the network endpoint. The network endpoint executes the remaining parts/layers and feeds the inference results back to the device.

Another supported type of AI/ML operation is illustrated in FIG. 3B. In the specific example of FIG. 3B, multi-functional mobile devices (such as, the first device 210 as shown in FIG. 2) might need to switch the AI/ML model in response to task and environment variations. The condition of adaptive model selection is that the models to be selected are available for the mobile device. However, given the fact that the AI/ML models are becoming increasingly diverse, and with the limited storage resource in a UE, it can be determined to not pre-load all candidate AI/ML models on-board. Online model distribution (i.e. new model downloading) is needed, in which an AI/ML model can be distributed from a NW endpoint (such as the second device 220 as shown in FIG. 2) to the mobile devices when they need it to adapt to the changed AI/ML tasks and environments. For this purpose, the model performance at the UE needs to be monitored constantly.

A further supported type of AI/ML operation is illustrated in FIG. 3C. In the specific example of FIG. 3C, an AI/ML server 350 (such as a cloud server) trains a global model by aggregating local models partially-trained by each end devices. Within each training iteration, a UE (such as, such as the first device 210 as shown in FIG. 2) performs the training based on the model downloaded from the AI/ML server 350 using the local training data. Then the UE reports the interim training results to the AI/ML server 350 via such as the fifth generation (5G) uplink channels. The AI/ML server 350 aggregates the interim training results from the UEs and updates the global model. The updated global model is then distributed back to the UEs and the UEs can perform the training for the next iteration.

It is to be understood that the above types of AI/ML operation are illustrated only for the purpose of illustration without suggesting any limitations. The implementation of the present discourse is not limited to specific types of AI/ML operation.

### Example Processes

It should be understood that although feature(s)/operation(s) are discussed in specific example embodiments separately, unless clearly indicated to the contrary, these feature(s)/operation(s) described in different example embodiments may be used in any suitable combination.

It is clarified that the first device 210 and the second device 220 discussed herein are the counterparts for each other. Specifically, both the first device 210 and the second device 220 may exchange capability-related information with each other, receive one or more ML models, apply one or more configurations for the ML model, run one or more ML models, generate an inference result by the ML model, generate a measurement result corresponding to the ML model, detect the inference state of the ML model, exchange state information of the ML model, initiate and/or perform an updated procedure for a mL model and so on. Further, the above procedure/operation performed by the first device 210 and the second device 220 are similar and corresponding. Therefore, although some discussion are discussed with regards to the first device 210 or the second device 220, those discussions also may be equivalent applied to the other device of the first device 210 and the second device 220. Merely for brevity, some same or similar contents are omitted.

In addition, in the following description, some interactions are performed among the devices (such as, a first device 210 and a second device 220, or a second device 220-1 and a further second device 220-2). It is to be understood that the interactions may be implemented either in one single signaling/message or multiple signaling/messages, including system information, radio resource control (RRC) message, DCI message, uplink control information (UCI) message, MAC CE and so on. The present disclosure is not limited in this regard.

In addition, in the following example embodiments, messages (including, a first message, a second message, a third message, a fourth message, a triggering message, an activation message, a deactivation message and other message) may be transmitted to either of the first device 210 and the second device 220. It is clarified that any of the message discussed in the present discourse may be transmitted specifically to a particular cell, a particular cell group, a particular first device 210, a particular first device group, a particular functionality, a particular collaboration level, a particular architecture, a particular algorithm and the likes.

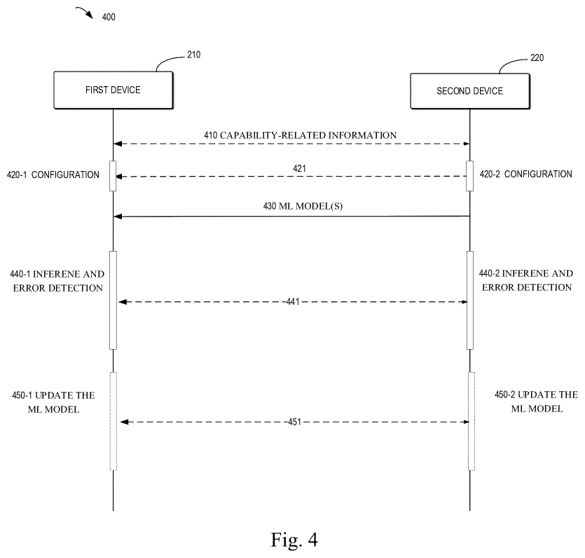

Principle and implementations of the present disclosure will be described in detail below with reference to FIG. 4, which shows a signaling chart illustrating a process 400 of communication according to some example embodiments of the present disclosure. For the purpose of discussion, the process 400 will be described with reference to FIG. 2. The process 400 may involve the first device 210 and the second device 220.

Optionally, the first device 210 may communicate capability-related information with the second device 220, such that the second device 220 may perform an efficient ML model distribution and generate a more proper configuration for the related ML model. As illustrated in FIG. 4, the first device 210 transmits 410 capability-related information to the second device 220.

One example of the capability-related information is whether the first device 210 supports to detect an inference error of a ML model. For example, the capability-related information indicates whether the first device 210 can support the introduced first duration, the second duration and/or the ML model inference cycle.

Another example of the capability-related information is a number of ML models configured to the first device 210. For example, the capability-related information is a capability of the first device 210 on a number of simultaneously configured/applied ML models.

A further example of the capability-related information is information about the ML model supported by the first device 210.

In one specific example embodiment, the capability-related information is the information about ML model collaboration level supported by the first device 210, where the ML model collaboration level may be any of collaboration level, including: no collaboration, network (NW) only, UE only, inter-node assistance, joint ML operation, split operation, federated learning (FL), downloadable and so on. In some embodiments, the ML model collaboration level ‘no collaboration’ at least includes: non-collaboration framework, where one or more AI/ML algorithms are purely implemented without requiring any improvements on the air-interface changes; and non-collaboration framework with modified Air-Interface catering to efficient implementation-based AI/ML algorithms.

Alternatively, in some embodiments, in case that the ML model collaboration level ‘inter-node assistance’ applies, either of the UE (such as, the first device 210) and the network devices (such as, the second device 220) obtains assistance (for training, adaptation and so on) from the other of the UE and the network device. The ML model collaboration level ‘inter-node assistance’ does not require model exchange between the UE and the network device. Alternatively, in some embodiments, the ML model collaboration level ‘joint ML operation’ requires ML model and/or instruction exchange between the UE and the network device.

In another specific example embodiment, the capability-related information is the information about ML model architecture supported by the first device 210. Specifically, the ML model architecture may be associated with a number or a maximum number of layers, a number or a maximum number of hidden layers, layer types, layer shapes (i.e., filter size, a number of channels/filters), a number and a maximum number of neurons per each layer, a number and a maximum number of neurons, and connections between layers and so on. For example, the ML model may be a multilayer perceptrons (MLPs), convolution neural networks (CNNs), and recurrent neural networks (RNNs) and so on.

In a further specific example embodiment, the capability-related information is the information about ML functionality supported by the first device 210, where the ML functionality may be ML-based or ML-assisted CSI feedback, beam management, low overhead RS, positioning, mobility and so on.

In some embodiments, the ML-based or ML-assisted CSI feedback may include CSI feedback compression and recovery, joint CSI predication at NW and UE based on limited CSI-RS transmission, sounding reference signal (SRS) transmission or CSI feedback (in time-domain, frequency-domain, spatial-domain, antenna-port-domain and so on), CSI predication at NW based on limited CSI feedback (in time-domain, frequency-domain, spatial-domain, antenna-port-domain and so on), CSI predication at NW based on limited SRS transmission (in time-domain, frequency-domain, spatial-domain, antenna-port-domain and so on), CSI predication at UE based on limited CSI-RS transmission (in time-domain, frequency-domain, spatial-domain, antenna-port-domain and so on).

Alternatively, in some embodiments, the ML-based or ML-assisted beam management may include joint beam selection or predication at NW and UE based on limited CSI-RS transmission, SRS transmission or beam report (in time-domain, frequency-domain, spatial-domain, antenna-port-domain and so on), beam selection at NW to infer the best beam based on subset of resources for measurement and report, beam selection at UE to infer the best beam based on limited CSI-RS transmission, beam prediction at NW based on limited beam report (in time-domain, frequency-domain, spatial-domain, antenna-port-domain and so on), beam predication at NW based on limited SRS transmission in time-domain, frequency-domain, spatial-domain, antenna-port-domain and so on, beam predication at UE based on limited CSI-RS transmission (in time-domain, frequency-domain, spatial-domain, antenna-port-domain and so on).

Alternatively, in some embodiments, the ML-based or ML-assisted low overhead RS may include low overhead SSB/CSI-RS/SRS/PTRS/UL DMRS/DL DMRS (in time-domain, frequency-domain, spatial-domain, antenna-port-domain and so on).

Another further example of the capability-related information is information about ML computation power. Specifically, the ML computation power may be identified by a total ML computation power, a ML computation power for each ML model and so on.

The other capability-related information may directly indicate a certain index of a ML model/a type of ML model, a ML model for a specific algorithm and so on. Further, a ML model for a specific algorithm may be associated with learning rate, loss function, cost function, activation function, mini-batch size, number of training iterations, momentum, number of hidden units, weight decay, activation sparsity, nonlinearity, weight initialization, regularization constant, number of epochs, number of branches in a decision tree, number of clusters in a clustering algorithm and any other hyper-parameters.

Similarly, the second device 220 also may provide similar capability-related information to the first device 210. Further, the second device 220 also may provide its capability-related information to a further second device 220. For example, the second device 220-1 (i.e., a network device) transmits its capability-related information to a further second device 220-2 (i.e., a ML function controller).

The capability-related information of the second device 220 is similar with those of the first device 210. Merely for brevity, the same or similar contents are omitted here.

It is to be understood that the above examples of capability-related information are only for the purpose of illustration without suggesting any limitations. In some other example embodiments, any suitable capability-related information may be exchanged among the related devices (such as, among any two of the first devices 210-1 and 210-2 and the second devices 220-1 and 220-2). The present disclosure is not limited in this regard.

In addition, the capability-related information may be carried in any suitable signalling/message(s), including but not limited to system information, RRC message, DCI message, UCI message, MAC CE and so on.

By exchanging the capability-related information, the second device 220 (either a network device or a ML function controller) may perform an efficient ML model distribution and generate a more proper configuration for a ML model.

Further, according to some embodiments, an improved ML distribution procedure is proposed. In some embodiments, one or more ML models may be distributed in the network. In the specific example of FIG. 4, the second device 220 transmits 430 the one or more ML models to the first device 210.

Additionally, in some embodiments, in case that the first device 210 supports to be concurrently configured/applied with multiple ML models, more than one ML model may be transmitted to the first device 210.

In some embodiments, the one or more ML models may be transmitted with a specific RNTI. In other words, one or more RNTIs may be defined/introduced specifically for ML model distribution. Additionally, in one specific example, a new group-specific common RNTI may be defined/introduced.

Alternately, or in addition, in some embodiments, the one or more ML models may be transmitted with a specific scrambling ID. In other words, one or more scrambling IDs may be defined/introduced specifically for ML model distribution. Additionally, in one specific example embodiment, a scrambling ID may be configured for a PDCCH/PDSCH/PUCCH/PUSCH and/or the respective DMRS.

Alternately, or in addition, in some embodiments, the one or more ML models is transmitted with a specific RRC message, a specific MAC CE logic channel ID (LCID).

Alternately, or in addition, in some embodiments, the one or more ML models is transmitted via a group common transmission or broadcast.

Alternately, or in addition in some embodiments, the one or more ML models is transmitted via any or a combination of the following, physical downlink control channel(s), PDCCH(s), PDCCH(s) scrambled by a specific RNTI or a specific scrambling ID, group-common PDCCH, physical downlink shared channel(s), PDSCH(s), PDSCH(s) scrambled by a specific RNTI or a specific scrambling ID, group-common PDSCH(s), paging messages(s), system information, short message(s) and the likes. Alternatively, in some other embodiments, the one or more ML models is transmitted via any or a combination of the following, physical uplink control channel(s), PUCCH(s), PUCCH(s) scrambled by a specific RNTI or a specific scrambling ID, uplink downlink shared channel(s), PUSCH(s), PUSCH(s) scrambled by a specific RNTI or a specific scrambling ID and the likes.

In this way, since the NW (such as, the second device 220) is unlikely to train separate ML model for each UE (such as, the first device 210), the efficiency of ML model distribution procedure is improved by using group common transmission or broadcast.

Alternately, in some other embodiments, the one or more ML models is transmitted via unicast, which enables a UE-specific ML model distribution.

Alternately, or in addition, in some embodiments, the one or more ML models are monitored via a specific radio resource configuration, such as, a specific CORESET, or a specific search space set. In this way, it is only needed to monitor a specific search space or CORESET to obtain the scheduling of ML model distribution.

In some embodiments, the transmitted multiple ML models maybe used for a same functionality/use case. Alternatively, the transmitted multiple ML models maybe used for different functionalities/use cases.

In some embodiments, the multiple ML models may be listed and indexed. Specifically, each of the multiple ML models may be assigned with an index/identity. In some embodiments, the index/identity is in ascending or in descending order per a particular cell, a particular cell group, a particular first device 210, a particular first device group, or a particular functionality.

In some embodiments, the one or more ML models itself may be transmitted. Alternatively, the one or more ML models may be indicated to the related network by using at least one parameter/information associated with the one or more ML models, such as, ML Model architectures, algorithms, hyper-parameters and so on. Alternatively, the one or more ML models may be indicated to the related network by using the index(es)/identity(ies) of the one or more ML models.

In addition, the one or more ML models maybe transmitted conditionally. Specifically, in some embodiments, the one or more ML models are transmitted only if a communication situation between the first device 210 and the second device 220 meets a pre-configured condition. The communication situation may be identified by a quality of service (QOS) requirement (such as, rate, modulation and coding scheme (MCS), bandwidth, block error rate (BLER), latency and any other suitable QoS requirements). In one example embodiment, the ML model(s) is distributed only when a certain QoS requirement satisfied. In this way, the successful ML model delivery is ensured.

It is to be understood if the second device 220 needs to receive ML model, the second device 220 also may perform similar procedures as discussed with regard to the first device 210.

Additionally, one or more configuration for the one or more ML models may be transmitted to either of the first device 210 and the second device 220. In some embodiments, the one or more configuration may be specific to a particular cell, a particular cell group, a particular first device 210, a particular first device group, or a particular functionality. In this way, the one or more ML models may be configured/activated flexibly.

The triggering procedure, activation/deactivation procedure and the configuration procedure may be implemented by either a single message/signaling or a plurality of separated messages/signalings, including system information, RRC, MAC-CE, UCI, DCI and so on. Additionally, in some embodiments, the message/signaling may indicate the specific ML model index(es)/identify(ies). Alternatively, some default rule may be defined for applying the one or more configuration. For example, the ML model with the lowest index may be considered as the ML model to be applied by default.

It is should be understood that the transmission of the one or more messages/signalings for triggering, activating/deactivating and configuration may performed in manners similar with those of the ML model distribution. For example, the one or more messages/signalings may be transmitted/monitored with a specific RNTI, a specific scrambling ID, a specific CORESET, a specific search space set, a specific MAC CE LCID and so on. Merely for brevity, the more details for transmuting the one or more messages/signalings are omitted here.

Additionally, in some embodiments, the one or more messages/signalings may be generated based on the above-discussed capability-related information. Alternatively, in some other example embodiments, the one or more messages/signalings are generated independently from the above-discussed capability-related information.

As discussed above, it is desirable to detect the inference error of the ML to avoid the performance degradation. In other words, it is expected that each applied ML model should be validated. According to some embodiments, the detecting of the inference error of the ML may be achieved by configuring at least one first duration during which the device (either the first device 210 or the second device 220) may obtain both of real measurement results and inference results. In other words, the first duration is used to monitor the performance of ML model. By comparing the real measurement results with the inference results, the inference error may be determined/detected.

As illustrated in FIG. 4, the first device 210 obtains 420-1 at least one configuration associated with a ML model, where the at least one configuration indicates at least one first duration to obtain both an inference result generated by the ML model and a measurement result corresponding to the ML model. In the specific example of FIG. 4, the first device 210 receives 421 the at least one configuration from the second device 220. In some embodiments, the second device 220 may be a network device. Alternatively, in some other embodiments, the second device 220 may be a ML function controller.

Correspondingly, the second device 220 also may obtain 420-2 the corresponding at least one configuration. As one specific example embodiment, the second device 220 (either may be a network device or a ML function controller) generates the corresponding at least one configuration by itself. Alternatively, in another specific example embodiment, the second device 220 receives the at least one configuration from a further second device 220. For example, the second device 220-1 (such as, a network device) receives the at least one configuration from the second device 220-2 (such as, a ML function controller).

In some embodiments, the at least one first duration is aperiodic or semi-periodic. For example, one or more duration after applying the configuration may be configured as the at least one first duration. In some other example embodiments, the at least one first duration starts in response to a triggering message or an activation message. In some further example embodiments, the at least one first duration stops in response to a deactivation message. Additionally, the triggering message may be a DCI or a UCI, while the activation/deactivation message may be a MAC CE.

Alternatively, in some other embodiments, the at least one first duration is periodic. In this event, the at least one configuration may indicate some parameter to be used for determining the at least one first duration. One example parameter is a periodicity of the at least one first duration. Another example parameter is a first length (such as, X1 time units) of each of the at least one first duration. Specifically, a time unit may be any of a symbol, a slot, a subframe, a frame, a SFN, a millisecond and the likes.

Further, in some embodiments, the first length may be represented as a value of a first timer. In addition, a further example parameter is the information for determining a starting point to apply the at least one configuration.

In some embodiments, the information for determining the starting point may be a system frame number (SFN) or a slot number, such as, the starting point may be SFN0 and slot0. Further, a starting offset also may be configured. In one specific embodiment, the starting offset may be determined by (SFN*10+subframe number) mod (length of a ML model inference cycle).

Alternatively, in some other embodiments, each of the at least one first duration is a part of an inference cycle. Reference is now made to FIGS. 5A and 5B, the first durations 510-1 and 510-2 are parts of the inference cycles 550-1 and 550-2, respectively.

Additionally, in addition to the first duration, each inference cycle also may comprise a second duration, where the second duration is used to obtain the inference result. In one example embodiment, the second duration is after the first duration in the inference cycle. As illustrated in FIG. 5A, the second durations 520-1 and 520-2 are illustrated after respective first durations 510-1 and 510-2, respectively. That is, validate the ML model first, and then apply the model inference for a certain time. In some other embodiments, a first gap in time-domain can be defined or configured between the first duration and the second duration. Additionally, a length of the first gap (such as, X3 time units, where X3 may be 0, 1, 2, . . . ) is associated with a capability of the first device 210 and/or the second device 220. Alternatively, the length of the first gap may be stipulated/configured as a default value (such as, 0) defined/configured/stipulated by the wireless standards, the network operator or the service provider.

Alternatively, in another example embodiment, the second duration is before the first duration in the inference cycle. As illustrated in FIG. 5B, the second durations 520-1 and 520-2 are illustrated before respective first durations 510-1 and 510-2, respectively. That is, apply the model inference for a certain time first, and then check the performance. Additionally, in some other embodiments, a second gap in time-domain can be defined or configured between the second duration and the first duration. Further, a length of the second gap (such as, X4 time units, where X4 may be 0, 1, 2, . . . ) is associated with a capability of the first device 210 and/or the second device 220. Alternatively, the length of the second gap may be stipulated/configured as a default value (such as, 0) defined/configured/stipulated by the wireless standards, the network operator or the service provider.

Additionally, a validation duration may be configured at the beginning period. As illustrated in FIG. 5B, a validation duration 530 is configured at the beginning. During this validation duration, the ML model may be validated by using an inference error detecting procedure as discussed in the following. In some other embodiments, a third gap in time-domain can be defined or configured between the validation duration and the second duration. Additionally, a length of the third gap (such as, X5 time units, where X4 may be 0, 1, 2, . . . ) is associated with a capability of the first device 210 and/or the second device 220. Alternatively, the length of the third gap may be stipulated/configured as a default value (such as, 0) defined/configured/stipulated by the wireless standards, the network operator or the service provider.

Additionally, some parameters may be used for indicating the inference cycle, the first duration and/or the second duration. One example parameter is a periodicity of the inference cycle. Another example parameter is a first length of the first duration as discussed above. Another example parameter is a second length of the second duration (such as, X2 time units). Another example parameter is a length of the inference cycle (such as, X time units). Further, in some embodiments, the second length may be represented as a value of a second timer. In some other embodiments, the length of the inference cycle may be represented as a value of a third timer. The other example parameter also may be information for determining a starting point to apply the at least one configuration.

It is to be understood that the above example parameter indicated by the at least one configuration are given for illustrative purpose only. Any of the above example parameter may be configured as a default value. If so, this parameter is unnecessarily to be indicated. Further, any other suitable parameter also may be used for indicating the first duration, the second duration and the inference cycle. The present disclosure is not limited in this regard.

Additionally, in some embodiments, in addition to the first duration and the second duration, the inference cycle may further comprise a fourth duration used for ML model training, a fifth duration used for ML model testing, a sixth duration used for ML model switching and so on.

In addition, the inference cycle/the other duration (including the second duration, the third duration, the fourth duration and so on) may be configured/indicated similarly with the first duration.

For example, any of the inference cycle and the other duration may be configured/generated by either of the first device 210 and the second device 220.

Additionally, the inference cycle/the other duration may be aperiodic or semi-periodic. Specifically, one or more duration after applying the configuration may be configured as the inference cycle/the other duration. In some other example embodiments, the inference cycle/the other duration may start in response to a triggering message or an activation message. In some further example embodiments, the inference cycle/the other duration also may stop in response to a deactivation message. Additionally, the triggering message may be a DCI or a UCI, while the activation/deactivation message may be a MAC CE.

Alternatively, the inference cycle/the other duration may be periodic. In this event, the at least one configuration may indicate some parameter to be used for determining the inference cycle/the other duration, such as, a respective length of the inference cycle/the other duration, a respective periodicity of the inference cycle/the other duration and other suitable parameters. Further, in some embodiments, the respective length may be represented as a value of a first timer. In addition, a further example parameter is the information for determining a starting point to apply the at least one configuration.

Merely for brevity, more details about the inference cycle/the other duration are omitted here.

Alternatively, or in addition, any of the inference cycle and the duration(s) (i.e., the first duration, the second duration, the third duration, the fourth duration and so on) may be configured with a respective starting point. Specifically, the inference cycle is configured with starting point T₁, the first duration is configured with starting point T₂, the second duration is configured with starting point T₃, . . . , the nth duration is configured with starting point Tₙ₊₁. Further, some of the inference cycle and the duration may share a common starting point. For example, the inference cycle is configured with starting point Tₐ, the first and second durations are configured with starting point T_{b}, and the third and fourth durations are configured with starting point T_{c}. Additionally, the deactivation operations on the inference cycle and the duration are similar. In summary, any of the inference cycle and the duration(s) may start and stop separately. In this way, a more flexible configuration is achieved.

In some other embodiments, the at least one configuration may comprise different configurations which may associate with either of the first duration and the second duration. For example, multiple linked configurations may to be used in the first duration and the second duration. In addition, the linkage of the at least one configuration may be configured explicitly via pairing multiple configurations or be implicitly implied via associating IDs of configurations. Specially, the at least one configuration may be report configuration, measurement configuration, RS configurations, transmission configurations and so on.

Further, each of the different configurations may comprise a set of related parameters, while the set of related parameters may be defined for a particular functionality/use case, and the parameters in different sets may be different.

In some other embodiments, the at least one configuration comprises a first configuration (be represented as “configuration_1”) and a second configuration (be represented as “configuration_2”), where the first configuration is used for obtaining the measurement result corresponding to the ML model and the second configuration is used for obtaining the inference result generated by the ML model. Further, in some embodiments, the first configuration is not related to any ML model, for example, the first configuration is a normal/legacy measurement configuration.

As for functionality/use case of CSI compression and recovery, the at least one configuration may comprise: report quantity of a CSI report, the configured number of bits of a CSI report and so on. In some example, the first configuration may comprise: a first CSI, the quantity of CSI report sets as the configured number of bits M for compressed CSI and so on, while the second configuration may comprise: a second CSI, the quantity of CSI report sets as configured number of bits N for compressed CSI and so on. Further, in some embodiment, the configured number of bits M in the first configuration is larger than the configured number of bits N in the second configuration. Alternatively, or in addition, the first configuration may comprise a first CSI, the quantity of CSI report sets as at least one of the following, a high-resolution CSI, a type I CSI, a type II CSI, rank indicator (RI), precoding matrix indicator (PMI), CQI, layer indicator (LI) and so on.

Alternatively, as for functionality/use case of beam management, the at least one configuration may comprise: a resource set for beam selection, a periodicity of beam measurement and report and so on. In some example, the first configuration may comprise: a first resource set for beam selection, a periodicity of beam management RS, a report periodicity and so on, while the second configuration may comprise: a second set for beam selection and so on. Further, in some embodiment, the first set for beam selection comprised in the first configuration comprises more resources than those comprised in the second set for beam selection comprised in the second configuration.

Alternatively, as for functionality/use case of low overhead RS, the at least one configuration may comprise: a RS pattern, a frequency density, a periodicity, a number of antenna ports, a transmit power or energy per resource element (EPRE), and so on. In some example, the first configuration may comprise: a first RS with a first RS pattern, a first RS with a first frequency density, a first periodicity, a first number of antenna ports and so on, while the second configuration may comprise: a second RS with a second RS pattern, a second RS with a second frequency density, a second periodicity, a second number of antenna ports and so on. Further, in some embodiment, the first frequency density of the first configuration is larger than the second frequency density of the second configuration), a first periodicity is smaller than the second periodicity, and the first number of antenna ports is larger than the second number of antenna ports).

In one specific example embodiment, either of the first device 210 and the second device 220 may apply both the first and the second configurations during the at least first duration while apply the second configuration beyond the at least one first duration (such as, within the second durations). That is, during the first duration, the first device 210 and/or the second device 220 need to perform more measurements and reports according to the first configuration.

Next, the at least one configuration may be applied, i.e., performing inference and error detection. As illustrated in the FIG. 4, the first device 210 and the second device 220 apply 440-1 and 440-2 the at least one configuration, respectively.

In some embodiments, the at least one configuration may be applied according to the starting point indicated by the at least one configuration as discussed. Alternatively, in some other embodiments, the at least one configuration may be applied from a starting point determined in response to a specific operation. In one specific example embodiments, the starting point can be the time point of ACKing the reception of ML Model delivery, and the starting offset may be a certain value (such as, the first length of the first duration, X1). Specifically, the first device 210 applying the at least one configuration a certain period (such as, a first length of the first duration) after transmitting an ACK for the reception of ML Model delivery. In another specific example embodiment, the starting point can be the time point of sending/receiving information related to the validation of ML Model, and the starting offset may be a certain value. In another specific example embodiment, the second device 220 may transmit a trigger message to the first device 210. The first device 210 may apply the at least one configuration a certain period after receiving the trigger message.

For better understanding, one specific example embodiment for applying the at least one configuration comprising the above first configuration and the second configuration is discussed as below.

During the second duration, the configuration_2 is activated. Both the first device 210 and the second device 220 perform transmission and reception according to the configuration_2 and/or and the inference results obtained based on configuration_2. As for functionality/use case of CSI compression and recovery, the first device 210 and the second device 220 exchange the compressed version of CSI corresponding to the second CSI. In addition, the first device or the second device adopt the recovered version of CSI. Alternatively, as for functionality/use case of beam management, the first device 210 and the second device 220 adopt and/or exchange the inferenced best beam corresponding to best beam of the second set. Alternatively, as for functionality/use case of low overhead RS, the first device 210 and the second device 220 adopt and/or exchange the inferenced channel estimation results corresponding to the results obtain by measuring the second RS.

During the first duration, both the configuration_1 and configuration_2 are activated. The first device 210 and the second device 220 performs transmission and reception according to configuration_1 and configuration_2, and further the first device 210 and/or the second device 220 perform a validation procedure according to the actual measurement results (based on configuration_1) and ML model inference results (based on configuration_2) which will be discussed in the following text.

Alternatively, during the first duration, the configuration_1 is activated and the configuration_2 is deactivated. Both the first device 210 and the second device 220 perform transmission and reception according to the configuration_1 and/or and the measurement results obtained based on configuration_1.

Further, in order to save power, the first device 210 may be operated in some power saving mode, such as, a discontinuous reception (DRX) mode. According to some of the example embodiments of the present disclosure, some further improvements for the power saving mode are proposed as discussed below.

In the first duration, the power consumption and complexity is higher, which causes that the first duration is not suitable to be configured in those inactive duration of the DRX (i.e., non DRX ON time duration). Therefore, in some embodiments, if the first device 210 is operated in a DRX mode, the inference cycle is aligned with a DRX cycle of the DRX mode. Additionally, or in addition, in some embodiments, the first duration is aligned with the DRX ON time duration. In some embodiments, the second device 220 may generate aligned configurations for the DRX mode and ML model, respectively.

Alternatively, if the first device 210 is operated in a DRX mode, the inference result and the measurement result may be allowed to be obtained only during an active duration of a DRX cycle of the DRX mode. That is, the first device 210 only performs validation in the intersection of DRX ON time duration and the configured at least one first duration. Accordingly, if the first device 210 is operated in a DRX mode, the first duration will be skipped during an inactive duration of the DRX cycle.

Optionally, in some embodiments, when a plurality of ML models are applied by respective device, an initial validation procedure may be performed to select a ML model from the plurality of ML models. In the specific example embodiment of FIGS. 5A and 5B, an initial validation procedure may be performed during the first duration 510-1 as shown in FIG. 5A and the validation duration 530 as shown in FIG. 5B.

In one specific example embodiment, if the plurality of ML models is configured to the first device 210, the first device 210 selects one ML model from the plurality of ML models and transmits a first message indicating the selected ML model to the second device 220. Similarly, if a plurality of ML models is configured to the second device 220, the second device 220 also may select a ML model from the plurality of ML models and transmits a message indicating the selected ML model to the first device 210.

Further, when applying the at least configuration, either the first device 210 and the second device 220 may generate measurement results and/or inference results by themselves and exchange the measurement results and/or inference results with each other. Additionally, either of the first device 210 and the second device 220 also may determine the inference state of the ML models. According to some embodiments, the related information may be exchanged among the devices, such that the inference state of the ML model may be determined and aligned with each other.

As illustrated in FIG. 4, the first device 210 and the second device 220 exchange 441 the related information with each other. In the following text, some example exchanging procedures are discussed.

It is should be understood that any of the below exchanging procedure is optional and the below illustrated procedures may be performed independently or in any suitable combination. For example, if the first device 210 transmits the actual measurement results to the second device 220, the second device 220 may not necessarily transmit the actual measurement results to the first device 210. Similarly, if the first device 210 transmits a first indication indicating whether the inference error of the ML model occurs to the second device 220, the second device 220 may not necessarily transmit a corresponding second indication to the first device 210.

In a nutshell, the actual exchanging procedure may be performed on demand and according to the specific application scenario. The present disclosure is not limited in this regard.

In some example, during the first duration(s), the first device 210 obtains a first inference result generated by the ML model and a first measurement result (i.e., the actual measurement result) corresponding to the ML model and transmits the first inference result and the first measurement result to the second device 220.

Alternatively, or in addition, in some embodiments, the first device 210 may transmit a first difference between the first inference result and the first measurement result to the second device 220.

Alternatively, or in addition, in some embodiments, the first device 210 may determine the inference state of the ML model (as will be discussed below) and transmit a first indication indicating whether an inference error of the ML model occurs to the second device 220.

Additionally, the first device 210 may use one or more message (referred to as second message) to carry the above information. In some embodiments, the second message may include a cause for transmitting the second message. One example cause is ML model inference error. The other example causes include but not are limited to out-of-battery, out-of-MLComputationPower and so on.

In some embodiments, the second message is transmitted periodically. Alternatively, in some embodiments, the second message is transmitted only in response to detecting the inference error of the ML model.

Correspondingly, the first device 210 also may receive related information from the second device 220.

In some embodiments, the first device 210 receives a second inference result generated by the ML model at the second device 220 and a second measurement result corresponding to the ML model measured by the second device 220.

Alternatively, or in addition, in some embodiments, the first device 210 may receive a second difference between the second inference result and the second measurement result from the second device 220.

Similar with the first device 210, the second device 220 also may determine the inference state of the ML model (as will be discussed below). In this event, the first device 210 also may receive a second indication indicating whether an inference error of the ML model occurs from the second device 220.

Additionally, the second device 220 may use one or more message (referred to as fourth message) to carry the above information. In some embodiments, the fourth message may include a cause for transmitting the fourth message.

In some embodiments, the fourth message is transmitted periodically. Alternatively, in some embodiments, the fourth message is transmitted only in response to the detecting the inference error of the ML model.

With the above information, either the first device 210 or the second device 220 may determine whether the inference error of the ML model occurs (i.e., perform the validation procedure).

In some embodiments, the first device 210 may determine the inference state based on an inference result (generated by the ML model at either of the first device 210 and second device 220) and a measurement result corresponding to the ML model (measured by either of the first device 210 and second device 220).

Alternatively, or in addition, in some embodiments, the first device 210 may determine the inference state based on a difference between the inference result and the measurement result. In some embodiments, the validation procedure may be performed based on whether the difference between inference results and measurement results meets some conditions defined for ML model inference error.

It is to be understood that the detailed conditions for different use cases can be different. As for functionality/use case of CSI compression and recovery, the condition may be mean square error (MSE) threshold between the recovered CSI and the first CSI. As for functionality/use case of beam management, the condition may be that the probability that L1-RSRP between inferenced beam based on the second set and best beam of the first set being less than a threshold such as 3 dB. As for functionality/use case of low overhead RS, MSE threshold between inferenced channel from measurement of the second RS and the estimated channel from measurement of the first RS.

In some embodiments, the validation procedure is performed based on a statistical data (such as, an average value, a filter value) over the whole validation duration or over a sliding window in the validation duration rather than an one-time comparison.

Alternatively, or in addition, in some embodiments, the first device 210 may directly determine the inference state based on a second indication received from the second device 220, where the second indication indicates whether the inference error of the ML model occurs.

Similar operations may be performed by the second device 220. Specifically, in some embodiments, the second device 220 may determine the inference state based on an inference result (generated by the ML model at either of the first device 210 and second device 220) and a measurement result corresponding to the ML model (measured by either of the first device 210 and second device 220).

Alternatively, or in addition, in some embodiments, the second device 220 also may determine the inference state based on a difference between the inference result and the measurement result.

Alternatively, or in addition, in some embodiments, the second device 220 also may directly determine the inference state based on a first indication received from the first device 210, where the first indication indicates whether the inference error of the ML model occurs.

According to the above procedures, either the first device 210 or the second device 220 may determine whether the inference error occurs. Therefore, according to some embodiments of the present discourse, by providing supports to monitor ML model performance by comparison between ML model inference results and measurement results, the inference error may be well handled.

In some embodiments, if the first device 210/or the second device 220 determines that an inference error of the ML model occurs, the first device 210/or the second device 220 will disable generating the inference result by the ML model until a completion of updating the ML model. In other words, stop the inference cycle of the ML model if the inference error is detected. In one embodiment, the disabling generating the inference result is implemented by stopping the first duration or by setting a timer used for maintaining the first duration to be to ‘0’ or to be expired. In another embodiment, the disabling generating the inference result is implemented by setting a timer used for maintaining the inference cycle to be to ‘0’ or to be expired. Additionally, before the completion of updating the ML mode, the configuration_1 is activated and the configuration_2 is deactivated.

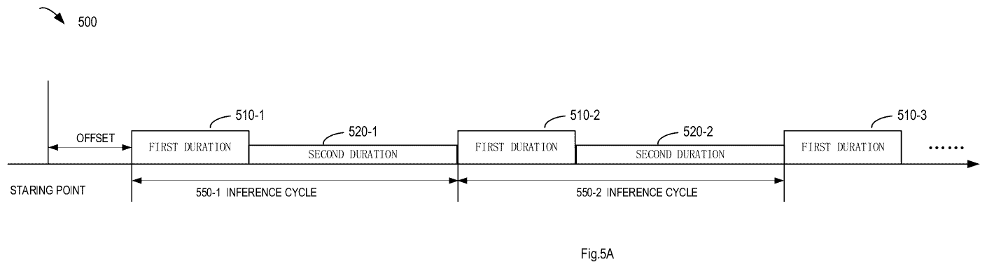

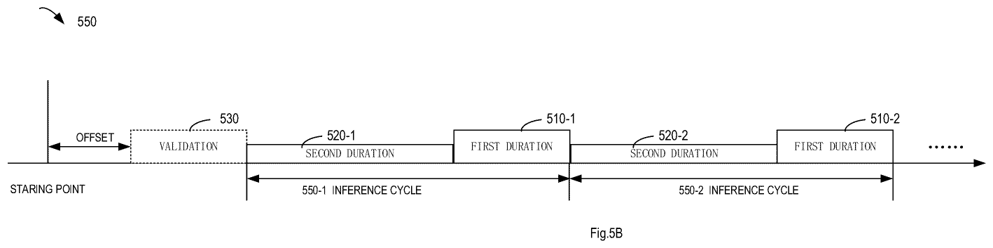

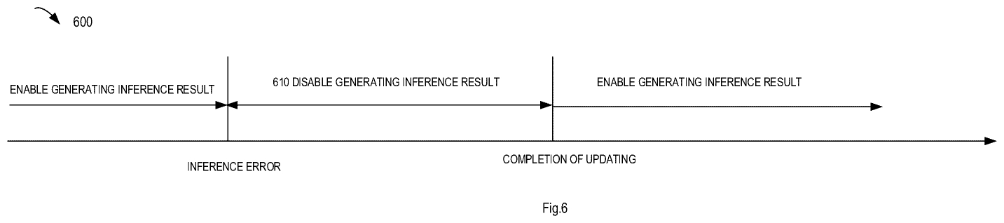

Reference is now made to FIG. 6. As illustrated in FIG. 6, during the period 610, the first device 210/or the second device 220 will disable generating the inference result. Additionally, during the period 610, the first device 210/or the second device 220 may perform a traditional measurement according to a previously-received configuration (such as, the first configuration as discussed above).

Alternatively, or in addition, the first device 210 and the second device 220 also may continue to using the ML model that occurs the inference error, for example, activate the configuration_2.

Alternatively, or in addition, the first device 210/or the second device 220 may exchange some information to indicate the details of the inference error or initiate an update procedure. As illustrated in FIG. 4, the first device 210 and the second device 220 update 450-1 and 450-2 the ML model. Further, some information may be exchanged 451 between the first device 210 and the second device 220.

In some embodiments, if the first device 210 determines that an inference error of the ML model occurs, the first device 210 may transmit information about the ML model that occurs the inference error to the second device 220. For example, the first device 210 transmits a third message which comprises an index/identity of the ML model to the second device 220.

Alternatively, or in addition, in some embodiments, the first device 210 may transmit information about a candidate ML model. For example, the first device 210 is configured with a plurality of ML models and determines that the currently-applied ML models occurs an inference error, the first device 210 may perform a validation procedure on the other configured ML models and select a candidate ML model. Additionally, the selected candidate ML model may be informed to the second device 220.

Similar operation for selecting the candidate ML model may be performed by the second device 220. Merely for brevity, same or similar contents are omitted here.

Further, in case that the candidate ML model is needed to be delivered, the distribution of the candidate ML model may be performed according to above discussed ML distribution procedure. For example, the candidate ML model may be delivered via a specific RNTI. Alternatively, or in addition, the candidate ML model is delivered via one of group common transmission and broadcast. Alternatively, or in addition, the candidate ML model is monitored via a specific radio resource configuration, such as, a specific CORESET, or a specific search space set. Alternatively, or in addition, the candidate ML model is delivered only if a communication situation between the first device 210 and the second device 220 meets a pre-configured condition. Alternately, or in addition, the candidate ML model is transmitted with a specific scrambling ID. Alternately, or in addition, the candidate ML model is transmitted with a specific RRC message, a specific MAC CE LCID. Alternately, or in addition, the candidate ML model is transmitted with any or a combination of the following, PDCCH(s), PDCCH(s) scrambled by a specific RNTI or a specific scrambling ID, group-common PDCCH, physical downlink shared channel(s), PDSCH(s), PDSCH(s) scrambled by a specific RNTI or a specific scrambling ID, group-common PDSCH(s), paging messages(s), system information, short message(s), PUCCH(s), PUCCH(s) scrambled by a specific RNTI or a specific scrambling ID, uplink downlink shared channel(s), PUSCH(s), PUSCH(s) scrambled by a specific RNTI or a specific scrambling ID and the likes.

Additionally, the candidate ML model itself may be transmitted. Alternatively, the candidate ML model may be indicated to the related network by using at least one parameter/information associated with the one or more ML models, such as, ML Model architectures, algorithms, hyper-parameters and so on. Alternatively, the candidate ML model may be indicated to the related network by using the index(es)/identity(ies) of the one or more ML models.

Merely for brevity, the more details for distribution the candidate ML model are omitted here.

In the above discussed procedures, the inference error is detected by configuring at least one first duration. In the following text, some other embodiments for detecting the inference error are described. For ease of discussion, in the below discussed embodiments, the first device 210 functions as a terminal device and the second device 220 functions as a network device.

In operation, the first device 210 and the second device 220 may optionally exchange capability-related information and at least one configuration with each other. Those procedures are similar as discussed above except that the at least one first duration is unnecessarily to be configured. Further, in some embodiments, the capability-related information also may be information about whether the terminal device supports event-triggered ML model inference error report. Alternatively, or in addition, in some embodiments, the capability-related information also may be information about whether the terminal device supports the detailed supported values of those events. In summary, any capability-related information associated with event-triggered ML model inference error report may be indicated by the terminal device. The present disclosure is not limited in this regard.

In some embodiments, concepts of ML model inference error event and event-triggered report are introduced. In some embodiments, the first device 210 detects a pre-defined event that indicates an inference error of a ML model, where the pre-defined event is defined specifically to a particular functionality on an air interface. Specifically, the pre-defined event may be defined via one or more indirect metric that may reflect the inference state of the ML model. In this event, the first device 210 may detect the inference error without performing an actual measurement and comparing the actual measurement result with the inference result.

Additionally, the pre-defined event may be defined according to different functionalities/use cases. As for functionality/use case of CSI compression and recovery (or low overhead CSI-RS), the pre-defined event may comprise one or more instances that the indicated MCS is apparently different from measured CSI, which implies incorrect compression and/or recovery/prediction of CSI. In one specific example embodiment, the pre-defined event may is the difference between indicated MCS and mapped MCS according to the measured CQI exceeds a threshold.

Alternatively, as for functionality/use case of beam management, the pre-defined event may comprise one or more instances that indicated beam has a L1-RSRP much worse than reported beam, which implies a wrong selection of applied beam. Specifically, during the beam management, an indicated beam may be represented by RS ID associated with an indicated or activated TCI states, while a reported beam may be represented by RS ID reported in L1-RSRP or L1-SINR report. In one specific example embodiment, the pre-defined event may is the L1-RSRP difference between most recent indicated beam and the most recent reported beam exceeds a threshold.

Alternatively, as for functionality/use case of low overhead DMRS, the pre-defined event may comprise one or more instances that receiving not-Acknowledgement (NACK) when in a good channel condition, which implies the unsuccessful decoding is not due to low SNR but due to the ML model inference error of DMRS channel estimation. In one specific example embodiment, the pre-defined event may is that the number of consecutive NACKs exceeds a threshold, while the indicated MCS and mapping MCS according to SNR is smaller than a threshold.

Alternatively, or in addition, the pre-defined event may be associated with MCS-CQI mapping relationship, MCS-SNR mapping relationship and so on. In some embodiments, the MCS-CQI mapping relationship, MCS-SNR mapping relationship may be transmitted by the second device 220 to the first device 210. Alternatively, in some other embodiments, the MCS-CQI mapping relationship, MCS-SNR mapping relationship may be transmitted by the first device 210 to the second device 220.

In some embodiments, the first device 210 determines detecting the pre-defined event based on a statistical result during a certain period by using a timer or a counter. In one specific example embodiments, the first device 210 determines detecting the pre-defined event in case that the pre-defined event lasting over a certain period. In one specific example embodiments, the first device 210 determines detecting the pre-defined event in case that the number of the instances exceeds a threshold.

In case that the first device 210 detects the pre-defined event, the first device 210 may transmit some information to indicate the details of the inference error or initiate an update procedure as discussed above (Merely for brevity, some of the same or similar contents are omitted here).

In this way, by defining pre-defined event, the inference error of the ML models maybe well handled.

### Example Methods

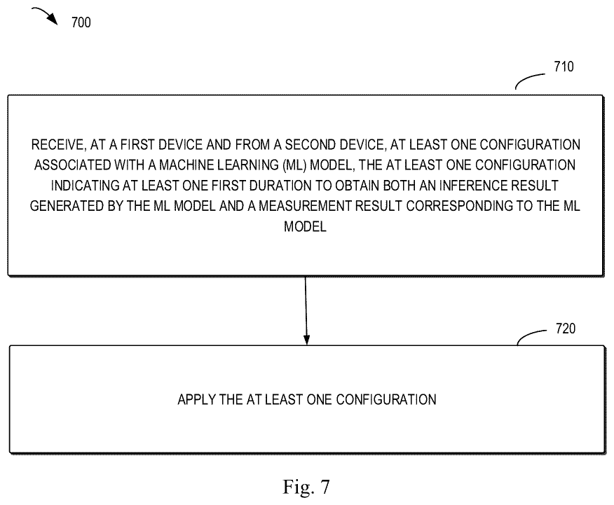

FIG. 7 illustrates a flowchart of an example method 700 in accordance with some embodiments of the present disclosure. For example, the method 700 can be implemented at the first device 210 as shown in FIG. 2.

At block 710, the first device 210 receives at least one configuration associated with a ML model from a second device 220, where the at least one configuration indicates at least one first duration to obtain both an inference result generated by the ML model and a measurement result corresponding to the ML model.

At block 720, the first device 210 applies the at least one configuration.

In some embodiments, the at least one first duration is periodic, and the at least one configuration indicates at least one of the following: a periodicity of the at least one first duration, a first length of each of the at least one first duration, or information for determining a starting point to apply the at least one configuration.

In some embodiments, the at least one configuration indicates: a first configuration for obtaining the measurement result corresponding to the ML model, and a second configuration for obtaining the inference result generated by the ML model.

In some embodiments, each of the at least one first duration is a part of an inference cycle, the inference cycle comprising: a first duration of the at least one first duration, and a second duration to be used by the first device 210 to obtain the inference result, the second duration being before or after the first duration in the inference cycle.

In some embodiments, the at least one configuration indicates at least one of the following: a periodicity of the inference cycle, a first length of the first duration, a second length of the second duration, or information for determining a starting point to apply the at least one configuration.

In some embodiments, if the first device 210 is operated in a DRX mode, the inference cycle is aligned with a DRX cycle of the DRX mode.

In some embodiments, if the first device 210 is operated in a DRX mode, the first device 210 obtains the inference result and the measurement result within the first duration during an active duration of a DRX cycle of the DRX mode, or the first device 210 skips the first duration during an inactive duration of the DRX cycle.

In some embodiments, the first device 210 selects one ML model from a plurality of ML models if the plurality of ML models is configured to the first device 210 and transmits a first message indicating the selected ML model to the second device 220.

In some embodiments, the first device 210 transmits a second message to the second device 220, where the second message indicates at least one of the following: a first inference result generated by the ML model at the first device 210, a first measurement result corresponding to the ML model measured by the first device 210, a first difference between the first inference result and the first measurement result, a first indication determined by the first device 210, indicating whether an inference error of the ML model occurs, or a cause for transmitting the second message.

In some embodiments, the second message is transmitted periodically or only in response to detecting the inference error of the ML model.

In some embodiments, the first device 210 transmits a third message to the second device 220 if an inference error of the ML model occurs, where the third message indicates at least one of the following: information about the ML model that occurs the inference error, information about a candidate ML model, or a cause for transmitting the third message.

In some embodiments, the first device 210 receives a fourth message from the second device 220, where the fourth message indicating at least one of the following: a second indication determined by the second device 220, indicating whether an inference error of the ML model occurs, a second inference result generated by the ML model at the second device 220, a second measurement result corresponding to the ML model measured by the second device 220, a second difference between the second inference result and the second measurement result, information about the ML model that occurs the inference error, information about a candidate ML model, or a cause for transmitting the fourth message.

In some embodiments, the first device 210 determines whether an inference error of the ML model occurs based on at least one of: an inference result generated by the ML model at either of the first and second device 220s, a measurement result corresponding to the ML model measured by either of the first and second device 220s, a difference between the inference result and the measurement result, or a second indication received from the second device 220, indicating whether the inference error of the ML model occurs.

In some embodiments, if the first device 210 determines that an inference error of the ML model occurs, the first device 210 updates the ML model to a candidate ML model.

In some embodiments, if the first device 210 determines that an inference error of the ML model occurs, the first device 210 disables generating the inference result by the ML model until a completion of updating the ML model.

In some embodiments, the first device 210 applies the at least one configuration from a starting point determined in response to a specific operation.

In some embodiments, the first device 210 is a terminal device, the second device 220 is a network device or a ML function controller and the ML model is a ML model used for an air interface.

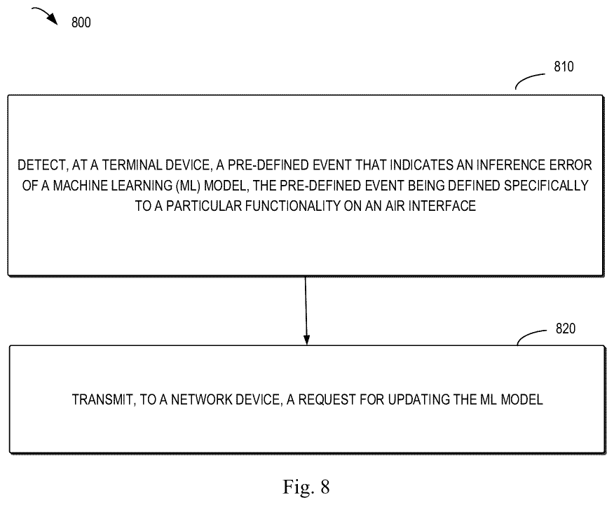

FIG. 8 illustrates a flowchart of an example method 800 in accordance with some embodiments of the present disclosure. For example, the method 800 can be implemented at a terminal device (such as, the first device 210 as shown in FIG. 2) as shown in FIG. 2.

At block 810, the terminal device detects a pre-defined event that indicates an inference error of a ML model, where the pre-defined event is defined specifically to a particular functionality on an air interface.

At block 820, the terminal device transmits a request for updating the ML model to a network device.

In some embodiments, the terminal device determines detecting the pre-defined event based on a statistical result during a certain period.

In some embodiments, the request indicates at least one of the following: a third indication determined by the terminal device, indicating that an inference error of the ML model occurs, information about the ML model that occurs the inference error, or information about a candidate ML model.

In some embodiments, in response to detecting the pre-defined event, the terminal device disables generating an inference result by the ML model until a completion of updating the ML model.

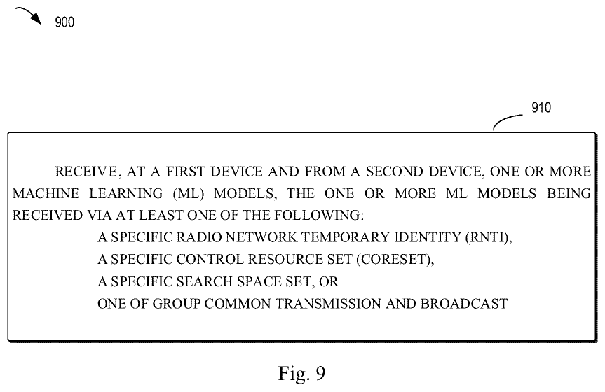

FIG. 9 illustrates a flowchart of an example method 900 in accordance with some embodiments of the present disclosure. For example, the method 900 can be implemented at the first device 210 as shown in FIG. 2.

At block 910, the first device 210 receives one or more ML models from a second device 220, where the one or more ML models is received via at least one of the following: a RNTI, a specific CORESET, a specific search space set, or one of group common transmission and broadcast.

In some embodiments, the first device 210 transmits capability-related information of the first device 210 to the second device 220, where the capability-related information indicates at least one of the following: whether the first device 210 supports to detect an inference error of a ML model, a number of ML models configured to the first device 210, information about ML model collaboration level supported by the first device 210, information about ML model architecture supported by the first device 210, or information about ML functionality supported by the first device 210.

In some embodiments, the first device 210 receives at least one configuration for the one or more ML models from the second device 220, where the at least one configuration is specific to at least one of the following: a particular cell, a particular cell group, a particular first device 210, a particular first device 210 group, or a particular functionality.

In some embodiments, the first device 210 is a terminal device, the second device 220 is a network device or a ML function controller and the ML model is a ML model used for an air interface.

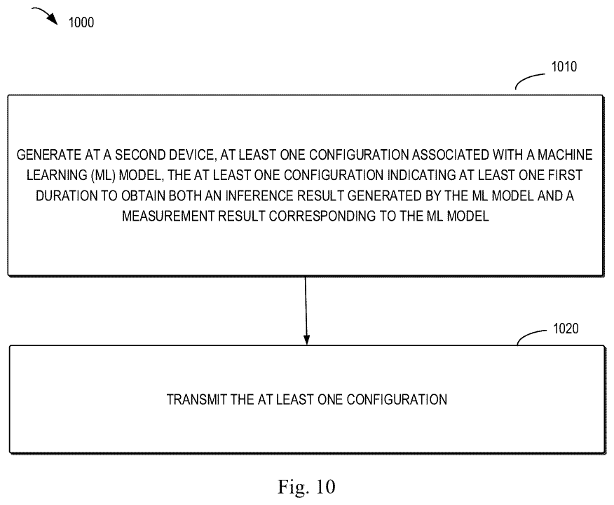

FIG. 10 illustrates a flowchart of an example method 1000 in accordance with some embodiments of the present disclosure. For example, the method 1000 can be implemented at the second device 220 as shown in FIG. 2.

At block 1010, the second device 220 generates at least one configuration associated with a ML model, where the at least one configuration indicates at least one first duration to obtain both an inference result generated by the ML model and a measurement result corresponding to the ML model

At block 1020, the second device 220 transmits the at least one configuration.

In some embodiments, the at least one first duration is periodic, and the at least one configuration indicates at least one of the following: a periodicity of the at least one first duration, a first length of each of the at least one first duration, or information for determining a starting point to apply the at least one configuration.

In some embodiments, the at least one configuration comprises: a first configuration for obtaining the measurement result corresponding to the ML model, and a second configuration for obtaining the inference result generated by the ML model.

In some embodiments, each of the at least one first duration is a part of an inference cycle, the inference cycle comprising: a first duration of the at least one first duration, and a second duration to be used by the first device 210 to obtain the inference result, the second duration being before or after the first duration in the inference cycle.

In some embodiments, the at least one configuration indicates at least one of the following: a periodicity of the inference cycle, a first length of the first duration, a second length of the second duration, or information for determining a starting point to apply the at least one configuration.

In some embodiments, if the first device 210 is operated in a DRX mode, the inference cycle is aligned with a DRX cycle of the DRX mode.

In some embodiments, the second device 220 transmits a plurality of ML models to the first device 210, and receives a first message from the first device 210, where the first message indicating a ML model selected by the first device 210 from the plurality of ML models.

In some embodiments, the second device 220 receives a second message from the first device 210, where the second message indicating at least one of the following: a first inference result generated by the ML model at the first device 210, a first measurement result corresponding to the ML model, a first difference between the first inference result and the first measurement result, a first indication determined by the first device 210, indicating whether an inference error of the ML model occurs, or a cause for transmitting the second message.

In some embodiments, the second device 220 receives a third message from the first device 210, where the third message indicating at least one of the following: information about the ML model that occurs the inference error, information about a candidate ML model, or a cause for transmitting the third message.

In some embodiments, the second device 220 transmits a fourth message to the first device 210, where the fourth message indicating at least one of the following: a second indication determined by the second device 220, indicating whether an inference error of the ML model occurs, a second inference result generated by the ML model at the second device 220, a second measurement result corresponding to the ML model measured by the second device 220, a second difference between the second inference result and the second measurement result, information about the ML model that occurs the inference error, information about a candidate ML model, or a cause for transmitting the fourth message.

In some embodiments, the fourth message is transmitted periodically or only in response to detecting the inference error of the ML model.

In some embodiments, the second device 220 determines whether an inference error of the ML model occurs based on at least one of: an inference result generated by the ML model at either of the first and second device 220s, the measurement result corresponding to the ML model measured by either of the first and second device 220s, a difference between the inference result and the measurement result, or a first indication received from the first device 210, indicating whether the inference error of the ML model occurs.

In some embodiments, the first device 210 is a terminal device, the second device 220 is a network device or a ML function controller and the ML model is a ML model used for an air interface.

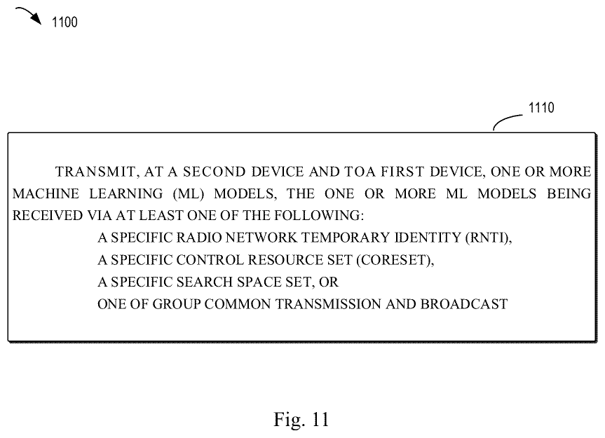

FIG. 11 illustrates a flowchart of an example method 1100 in accordance with some embodiments of the present disclosure. For example, the method 1100 can be implemented at the second device 220 as shown in FIG. 2.

At block 1110, the second device 220 transmits one or more ML models to a first device 210, where the one or more models is transmitted via at least one of the following: a RNTI, a specific CORESET, a specific search space set, or one of group common transmission and broadcast.

In some embodiments, the second device 220 receives capability-related information of the first device 210 from the first device 210, where the capability-related information indicates at least one of the following: whether the first device 210 supports to detect an inference error of a ML model, a number of ML models configured to the first device 210, information about ML model collaboration level supported by the first device 210, information about ML model architecture supported by the first device 210, or information about ML functionality supported by the first device 210.

In some embodiments, the second device 220 transmits at least one configuration for the one or more ML models to the first second device 220, where the at least one configuration is specific to at least one of the following: a particular cell, a particular cell group, a particular first device 210, a particular first device 210 group, or a particular functionality.

In some embodiments, the second device 220 transmits the one or more ML models if a communication situation between the first device 210 and the second device 220 meets a pre-configured condition.

In some embodiments, the first device 210 is a terminal device, the second device 220 is a network device or a ML function controller and the ML model is a ML model used for an air interface.

### Example Devices

In some embodiments, the first device 210 comprises circuitry configured to: receive at least one configuration associated with a ML model from a second device 220, where the at least one configuration indicates at least one first duration to obtain both an inference result generated by the ML model and a measurement result corresponding to the ML model; and apply the at least one configuration.

In some embodiments, the at least one first duration is periodic, and the at least one configuration indicates at least one of the following: a periodicity of the at least one first duration, a first length of each of the at least one first duration, or information for determining a starting point to apply the at least one configuration.

In some embodiments, the at least one configuration indicates: a first configuration for obtaining the measurement result corresponding to the ML model, and a second configuration for obtaining the inference result generated by the ML model.

In some embodiments, each of the at least one first duration is a part of an inference cycle, the inference cycle comprising: a first duration of the at least one first duration, and a second duration to be used by the first device 210 to obtain the inference result, the second duration being before or after the first duration in the inference cycle.

In some embodiments, the at least one configuration indicates at least one of the following: a periodicity of the inference cycle, a first length of the first duration, a second length of the second duration, or information for determining a starting point to apply the at least one configuration.

In some embodiments, if the first device 210 is operated in a DRX mode, the inference cycle is aligned with a DRX cycle of the DRX mode.

In some embodiments, if the first device 210 is operated in a DRX mode, the circuitry is further configured to: obtain the inference result and the measurement result within the first duration, during an active duration of a DRX cycle of the DRX mode, or skip the first duration during an inactive duration of the DRX cycle.

In some embodiments, the circuitry is further configured to: select a ML model from a plurality of ML models if the plurality of ML models is configured to the first device 210 and transmit a first message indicating the selected ML model to the second device 220.

In some embodiments, the circuitry is further configured to: transmit a second message to the second device 220, where the second message indicates at least one of the following: a first inference result generated by the ML model at the first device 210, a first measurement result corresponding to the ML model measured by the first device 210, a first difference between the first inference result and the first measurement result, a first indication determined by the first device 210, indicating whether an inference error of the ML model occurs, or a cause for transmitting the second message.

In some embodiments, the second message is transmitted periodically or only in response to detecting the inference error of the ML model.

In some embodiments, the circuitry is further configured to: transmit a third message to the second device 220 if an inference error of the ML model occurs, where the third message indicates at least one of the following: information about the ML model that occurs the inference error, information about a candidate ML model, or a cause for transmitting the third message.

In some embodiments, the circuitry is further configured to: receive a fourth message from the second device 220, where the fourth message indicating at least one of the following: a second indication determined by the second device 220, indicating whether an inference error of the ML model occurs, a second inference result generated by the ML model at the second device 220, a second measurement result corresponding to the ML model measured by the second device 220, a second difference between the second inference result and the second measurement result, information about the ML model that occurs the inference error, information about a candidate ML model, or a cause for transmitting the fourth message.

In some embodiments, the circuitry is further configured to: determine whether an inference error of the ML model occurs based on at least one of: an inference result generated by the ML model at either of the first and second device 220s, a measurement result corresponding to the ML model measured by either of the first and second device 220s, a difference between the inference result and the measurement result, or a second indication received from the second device 220, indicating whether the inference error of the ML model occurs.

In some embodiments, if the first device 210 determines that an inference error of the ML model occurs, the circuitry is further configured to: update the ML model to a candidate ML model.

In some embodiments, if the first device 210 determines that an inference error of the ML model occurs, the circuitry is further configured to: disable generating the inference result by the ML model until a completion of updating the ML model.

In some embodiments, the circuitry is further configured to: apply the at least one configuration from a starting point determined in response to a specific operation.

In some embodiments, the first device 210 is a terminal device, the second device 220 is a network device or a ML function controller and the ML model is a ML model used for an air interface.

In some embodiments, the terminal device (such as, the first device 210 as shown in FIG. 2) comprises circuitry configured to: detect a pre-defined event that indicates an inference error of a ML model, where the pre-defined event is defined specifically to a particular functionality on an air interface; and transmit a request for updating the ML model to a network device.

In some embodiments, the circuitry is further configured to: determine detecting the pre-defined event based on a statistical result during a certain period.

In some embodiments, the request indicates at least one of the following: a third indication determined by the terminal device, indicating that an inference error of the ML model occurs, information about the ML model that occurs the inference error, or information about a candidate ML model.

In some embodiments, in response to detecting the pre-defined event, the circuitry is further configured to: disable generating an inference result by the ML model until a completion of updating the ML model.
the first device 210 comprises circuitry configured to: receive one or more ML models from a second device 220, where the one or more ML models is received via at least one of the following: a RNTI, a specific CORESET, a specific search space set, or one of group common transmission and broadcast.

In some embodiments, the circuitry is further configured to: transmit capability-related information of the first device 210 to the second device 220, where the capability-related information indicates at least one of the following: whether the first device 210 supports to detect an inference error of a ML model, a number of ML models configured to the first device 210, information about ML model collaboration level supported by the first device 210, information about ML model architecture supported by the first device 210, or information about ML functionality supported by the first device 210

In some embodiments, the circuitry is further configured to: receive at least one configuration for the one or more ML models from the second device 220, where the at least one configuration is specific to at least one of the following: a particular cell, a particular cell group, a particular first device 210, a particular first device 210 group, or a particular functionality.

In some embodiments, the first device 210 is a terminal device, the second device 220 is a network device or a ML function controller and the ML model is a ML model used for an air interface.

In some embodiments, the second device 220 comprises circuitry configured to: generate at least one configuration associated with a ML model, where the at least one configuration indicates at least one first duration to obtain both an inference result generated by the ML model and a measurement result corresponding to the ML model; and transmit the at least one configuration.

In some embodiments, the at least one first duration is periodic, and the at least one configuration indicates at least one of the following: a periodicity of the at least one first duration, a first length of each of the at least one first duration, or information for determining a starting point to apply the at least one configuration.

In some embodiments, the at least one configuration comprises: a first configuration for obtaining the measurement result corresponding to the ML model, and a second configuration for obtaining the inference result generated by the ML model.

In some embodiments, each of the at least one first duration is a part of an inference cycle, the inference cycle comprising: a first duration of the at least one first duration, and a second duration to be used by the first device 210 to obtain the inference result, the second duration being before or after the first duration in the inference cycle.

In some embodiments, the at least one configuration indicates at least one of the following: a periodicity of the inference cycle, a first length of the first duration, a second length of the second duration, or information for determining a starting point to apply the at least one configuration.

In some embodiments, if the first device 210 is operated in a DRX mode, the inference cycle is aligned with a DRX cycle of the DRX mode.

In some embodiments, the circuitry is further configured to: transmit a plurality of ML models to the first device 210, and receives a first message from the first device 210, where the first message indicating a ML model selected by the first device 210 from the plurality of ML models.

In some embodiments, the circuitry is further configured to: receive a second message from the first device 210, where the second message indicating at least one of the following: a first inference result generated by the ML model at the first device 210, a first measurement result corresponding to the ML model, a first difference between the first inference result and the first measurement result, a first indication determined by the first device 210, indicating whether an inference error of the ML model occurs, or a cause for transmitting the second message.

In some embodiments, the circuitry is further configured to: receive a third message from the first device 210, where the third message indicating at least one of the following: information about the ML model that occurs the inference error, information about a candidate ML model, or a cause for transmitting the third message.

In some embodiments, the circuitry is further configured to: transmit a fourth message to the first device 210, where the fourth message indicating at least one of the following: a second indication determined by the second device 220, indicating whether an inference error of the ML model occurs, a second inference result generated by the ML model at the second device 220, a second measurement result corresponding to the ML model measured by the second device 220, a second difference between the second inference result and the second measurement result, information about the ML model that occurs the inference error, information about a candidate ML model, or a cause for transmitting the fourth message.

In some embodiments, the fourth message is transmitted periodically or only in response to detecting the inference error of the ML model.

In some embodiments, the circuitry is further configured to: determine whether an inference error of the ML model occurs based on at least one of: an inference result generated by the ML model at either of the first and second device 220s, the measurement result corresponding to the ML model measured by either of the first and second device 220s, a difference between the inference result and the measurement result, or a first indication received from the first device 210, indicating whether the inference error of the ML model occurs.

In some embodiments, the first device 210 is a terminal device, the second device 220 is a network device or a ML function controller and the ML model is a ML model used for an air interface.

In some embodiments, the second device 220 comprises circuitry configured to: transmit one or more ML models to a first device 210, where the one or more models is transmitted via at least one of the following: a RNTI, a specific CORESET, a specific search space set, or one of group common transmission and broadcast.

In some embodiments, the circuitry is further configured to: receive capability-related information of the first device 210 from the first device 210, where the capability-related information indicates at least one of the following: whether the first device 210 supports to detect an inference error of a ML model, a number of ML models configured to the first device 210, information about ML model collaboration level supported by the first device 210, information about ML model architecture supported by the first device 210, or information about ML functionality supported by the first device 210.

In some embodiments, the circuitry is further configured to: transmit at least one configuration for the one or more ML models to the first second device 220, where the at least one configuration is specific to at least one of the following: a particular cell, a particular cell group, a particular first device 210, a particular first device 210 group, or a particular functionality.

In some embodiments, the circuitry is further configured to: transmit the one or more ML models if a communication situation between the first device 210 and the second device 220 meets a pre-configured condition.

In some embodiments, the first device 210 is a terminal device, the second device 220 is a network device or a ML function controller and the ML model is a ML model used for an air interface.

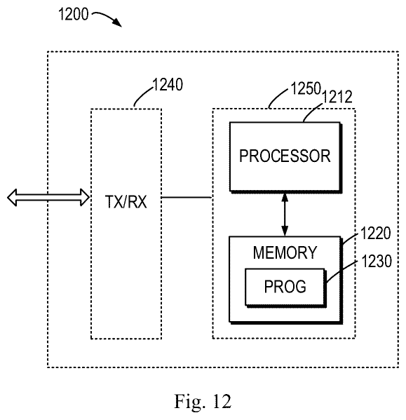

FIG. 12 is a simplified block diagram of a device 1200 that is suitable for implementing embodiments of the present disclosure. The device 1200 can be considered as a further example implementation of the first device 210 and the second device 220 as shown in FIG. 2. Accordingly, the device 1200 can be implemented at or as at least a part of the first device 210 and the second device 220.

As shown, the device 1200 includes a processor 1212, a memory 1220 coupled to the processor 1212, a suitable transmitter (TX) and receiver (RX) 1240 coupled to the processor 1212, and a communication interface coupled to the TX/RX 1240. The memory 1212 stores at least a part of a program 1230. The TX/RX 1240 is for bidirectional communications. The TX/RX 1240 has at least one antenna to facilitate communication, though in practice an Access Node mentioned in this application may have several ones. The communication interface may represent any interface that is necessary for communication with other network elements, such as X2 interface for bidirectional communications between eNBs, SI interface for communication between a Mobility Management Entity (MME)/Serving Gateway (S-GW) and the eNB, Un interface for communication between the eNB and a relay node (RN), or Uu interface for communication between the eNB and a terminal device.

The program 1230 is assumed to include program instructions that, when executed by the associated processor 1212, enable the device 1200 to operate in accordance with the embodiments of the present disclosure, as discussed herein with reference to FIGS. 2-11. The embodiments herein may be implemented by computer software executable by the processor 1212 of the device 1200, or by hardware, or by a combination of software and hardware. The processor 1212 may be configured to implement various embodiments of the present disclosure. Furthermore, a combination of the processor 1212 and memory 1220 may form processing means 1250 adapted to implement various embodiments of the present disclosure.

The memory 1220 may be of any type suitable to the local technical network and may be implemented using any suitable data storage technology, such as a non-transitory computer readable storage medium, semiconductor-based memory devices, magnetic memory devices and systems, optical memory devices and systems, fixed memory and removable memory, as non-limiting examples. While only one memory 1220 is shown in the device 1200, there may be several physically distinct memory modules in the device 1200. The processor 1212 may be of any type suitable to the local technical network, and may include one or more of general purpose computers, special purpose computers, microprocessors, digital signal processors (DSPs) and processors based on multicore processor architecture, as non-limiting examples. The device 1200 may have multiple processors, such as an application specific integrated circuit chip that is slaved in time to a clock which synchronizes the main processor.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 7-11. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1. A communication method, comprising:
receiving, at a first device and from a second device, at least one configuration associated with a machine learning (ML) model, the at least one configuration indicating at least one first duration to obtain both an inference result generated by the ML model and a measurement result corresponding to the ML model; and
applying the at least one configuration.

2. The method of claim 1, wherein the at least one first duration is periodic, and the at least one configuration indicates at least one of the following:
a periodicity of the at least one first duration,
a first length of each of the at least one first duration, or
information for determining a starting point to apply the at least one configuration.

3. The method of claim 1, wherein the at least one configuration indicates:
a first configuration for obtaining the measurement result corresponding to the ML model, and
a second configuration for obtaining the inference result generated by the ML model.

4. The method of claim 1, wherein each of the at least one first duration is a part of an inference cycle, the inference cycle comprising:
a first duration of the at least one first duration, and
a second duration to be used by the first device to obtain the inference result, the second duration being before or after the first duration in the inference cycle.

5. The method of claim 4, wherein the at least one configuration indicates at least one of the following:
a periodicity of the inference cycle,
a first length of the first duration,
a second length of the second duration, or
information for determining a starting point to apply the at least one configuration.

6. The method of claim 4, wherein if the first device is operated in a discontinuous reception (DRX) mode, the inference cycle is aligned with a DRX cycle of the DRX mode.

7. The method of claim 4, wherein if the first device is operated in a discontinuous reception (DRX) mode, applying the at least one configuration comprises:
during an active duration of a DRX cycle of the DRX mode, obtaining the inference result and the measurement result within the first duration, or
during an inactive duration of the DRX cycle, skipping the first duration.

8. The method of claim 1, further comprising:
selecting one ML model from a plurality of ML models if the plurality of ML models is configured to the first device; and
transmitting a first message indicating the selected ML model to the second device.

9. The method of claim 1, further comprising:
transmitting, to the second device, a second message indicating at least one of the following:
a first inference result generated by the ML model at the first device,
a first measurement result corresponding to the ML model measured by the first device,
a first difference between the first inference result and the first measurement result,
a first indication determined by the first device, indicating whether an inference error of the ML model occurs, or
a cause for transmitting the second message.

10. The method of claim 9, wherein the second message is transmitted periodically or only in response to detecting the inference error of the ML model.

11. The method of claim 1, further comprising:
transmitting a third message to the second device if an inference error of the ML model occurs, the third message indicating at least one of the following:
information about the ML model that occurs the inference error,
information about a candidate ML model, or
a cause for transmitting the third message.

12. The method of claim 1, further comprising:
receiving, from the second device, a fourth message indicating at least one of the following:
a second indication determined by the second device, indicating whether an inference error of the ML model occurs,
a second inference result generated by the ML model at the second device,
a second measurement result corresponding to the ML model measured by the second device,
a second difference between the second inference result and the second measurement result,
information about the ML model that occurs the inference error, or
information about a candidate ML model, or
a cause for transmitting the fourth message.

13. The method of claim 1, further comprising:
determining whether an inference error of the ML model occurs based on at least one of:
an inference result generated by the ML model at either of the first and second devices,
a measurement result corresponding to the ML model measured by either of the first and second devices,
a difference between the inference result and the measurement result, or
a second indication received from the second device, indicating whether the inference error of the ML model occurs.

14. The method of claim 1, further comprising:
if the first device determines that an inference error of the ML model occurs, updating the ML model to a candidate ML model.

15. The method of claim 1, further comprising:
if the first device determines that an inference error of the ML model occurs, disabling generating the inference result by the ML model until a completion of updating the ML model.

16. The method of claim 1, wherein applying the at least one configuration comprises:
applying the at least one configuration from a starting point determined in response to a specific operation.

17. The method of claim 1, wherein the first device is a terminal device, the second device is a network device or a ML function controller and the ML model is a ML model used for an air interface.

18-24. (canceled)

25. A communication method, comprising:
generating at a second device, at least one configuration associated with a machine learning (ML) model, the at least one configuration indicating at least one first duration to obtain both an inference result generated by the ML model and a measurement result corresponding to the ML model; and
transmitting the at least one configuration.

26. The method of claim 25, wherein the at least one first duration is periodic, and the at least one configuration indicates at least one of the following:
a periodicity of the at least one first duration,
a first length of each of the at least one first duration, or
information for determining a starting point to apply the at least one configuration.

27-41. (canceled)

42. A first device comprising:
a processor; and
a memory coupled to the processor and storing instructions thereon, the instructions, when executed by the processor, causing the first device to:
receive, from a second device, at least one configuration associated with a machine learning (ML) model, the at least one configuration indicating at least one first duration to obtain both an inference result generated by the ML model and a measurement result corresponding to the ML model; and
apply the at least one configuration.

43-45. (canceled)
